(19) United States
(12) Patent Application Publication
(10) Pub. No.: US 2011/0319139 A1
(43) Pub. Date: Dec. 29, 2011

(54) MOBILE TERMINAL, KEY DISPLAY PROGRAM, AND KEY DISPLAY METHOD

(76) Inventor: Masuo KONDO, Daito-shi (JP)

(21) Appl. No.: 13/168,156

(22) Filed: Jun. 24, 2011

(30) Foreign Application Priority Data
Jun. 25, 2010 (JP) 2010-145205

(51) Int. Cl. H04W 88/02; G06F 3/041

(52) U.S. Cl. 455/566; 345/173

(57) ABSTRACT

A mobile phone 10 comprises a display 30; a panel 38 that is disposed corresponding to the display 30; a touch detection section 36 that detects a touch operation corresponding to the panel 38; and a processor 24. On the display 30, soft keys 68 of a QWERTY layout are displayed. When a touch operation is performed with respect to the panel 38, the processor 24 inputs characters that correspond to the soft keys 68, based on the touch operation. The processor 24 predicts the characters to be input next, based on the characters that are input. The processor 24, when the characters are input based on the touch operation, predicts the characters to be input next, and enlarges the touch area of the keys corresponding to the characters.

### CROSS-REFERENCE TO RELATED APPLICATION

The present application claims priority under 35 U.S.C. §119 to Japanese Patent Application No. 2010-145205, filed on Jun. 25, 2010, entitled “MOBILE TERMINAL, KEY DISPLAY PROGRAM, AND KEY DISPLAY METHOD”. The content of which is incorporated by reference herein in its entirety.

### FIELD

Embodiments of the present disclosure relate generally to a mobile terminal, a key display program, and a key display method, and particularly relates to a mobile terminal, a key display program, and a key display method that can input characters, resulting from a touch operation.

### BACKGROUND

Conventionally, mobile terminals that can input characters, resulting from touch operations, are widely known. For example, a mobile information terminal device comprising a display device that displays a software keyboard and an input pen for inputting characters is well-known. Characters are input when arbitrary keys of the software keyboard are touched using the input pen in this mobile information terminal device. When characters are input, based on the Roman character conversion rule table, a key display corresponding to the subsequent input is enlarged and displayed. Another mobile terminal device is also well-known. The mobile terminal device includes a panel disposed on a display surface of a main display section that displays a plurality of icons, and 2 camera sections for proximity detection disposed in the vicinity of the main display section. This mobile terminal device enlarged and displayed the icon to which the finger of the user is approaching, when the finger of a user approaching with respect to the display surface of the display section is detected based on the images using the camera for proximity detection.

However, with the former mobile information terminal device, because the key display is enlarged and displayed, in the area surrounding the keys in which the keys are enlarged and displayed, the key display that is not enlarged and displayed is hidden. Therefore, it is difficult for the user to read the key display of keys that are not enlarged.

With the latter mobile information terminal device, when an icon for which the proximity of the finger is detected is enlarged, the display position of other icons changes; therefore, it is likely that the user is not able to correspond to changes in the display positions.

### SUMMARY

A mobile terminal, a key display program, and a key display method are disclosed.

In a first embodiment, a mobile terminal has a display section, a panel, a touch detection section, and a processor. The display section displays a plurality of character input keys. The panel is disposed, corresponding to the display section. The touch detection section detects a touch operation to the panel. The processor, when the touch operation to the panel is detected by the touch detection section, based on the touch operation, input the character input keys included in the plurality of character input keys that are displayed on the display section, and enlarges the touch area of the character input keys that are predicted to be input next so as not to overlap with the touch area of other character input keys.

In a second embodiment, a key display program causes a mobile terminal to function as a prediction section and a touch area enlargement section. The prediction section predicts characters most likely to be input next, when characters are input resulting from the touch operation. The touch area enlargement section enlarges the touch area of the character input keys corresponding to the characters that are predicted by the prediction section, so as not to overlap with the touch area of other character input keys.

In a third embodiment, a key display method has a step of predicting the characters most likely to be input next when the characters are input resulting from the touch operation and a step of enlarging the touch area of the character input keys corresponding to the predicted characters so as not to overlap with the touch area of other character input keys.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1 is a schematic diagram showing the electrical configuration of the mobile phone according to one embodiment of the present invention.

FIGS. 2A-2B are schematic diagram showing the external appearance of the mobile phone shown in FIG. 1.

FIGS. 3A-3B are schematic diagram showing changes in the position of the mobile phone shown in FIG. 1.

FIGS. 4A-4B are schematic diagram showing one example of soft keys displayed on the display shown in FIG. 1.

FIGS. 5A-5B are schematic diagram showing another example of soft keys displayed on the display shown in FIG. 1.

FIG. 6 is a schematic diagram showing one example of the configuration of the Roman character dictionary that is stored in the RAM shown in FIG. 1.

FIG. 7 is a schematic diagram showing the configuration of an enlargement table that is stored in the RAM shown in FIG. 1.

FIGS. 8A-8B are schematic diagram showing one example of the configuration of a normal key table that is stored in the RAM shown in FIG. 1.

FIGS. 9A-9B are schematic diagram showing one example of the configuration of an enlargement key table that is stored in the RAM shown in FIG. 1.

FIGS. 10A-10B are schematic diagram showing one example of the configuration of a display key table that is stored in the RAM shown in FIG. 1.

FIGS. 11A-11C are a schematic diagram showing one example of the configuration of the normal key shown in FIG. 4.

FIGS. 12A-12B are schematic diagram showing one example of the configuration of the enlargement key shown in FIG. 5.

FIGS. 13A-13B are schematic diagram showing another example of the configuration of the enlargement key shown in FIG. 5.

FIG. 14 is a schematic diagram showing one example of a memory map of the RAM shown in FIG. 1.

FIG. 15 is a schematic diagram showing one example of the data storage area shown in FIG. 14.

FIG. 16 is a flow diagram showing the key display processing of the processor shown in FIG. 1.

FIG. 17 is a flow diagram showing the touch area change processing of the processor shown in FIG. 1.

FIG. 18 is a flow diagram showing the touch area change processing of another embodiment of the processor shown in FIG. 1.

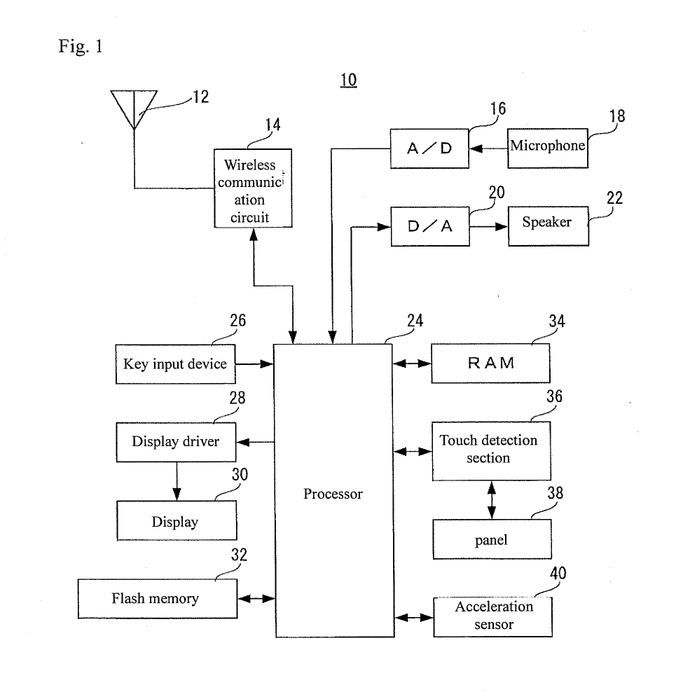

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding field, background, summary or the following detailed description. The present disclosure should be accorded scope consistent with the claims, and not limited to the examples described and shown herein.

Embodiments of the disclosure are described herein in the context of one practical non-limiting application, namely, an information device. Embodiments of the disclosure, however, are not limited to such mobile information devices, and the techniques described herein may also be utilized in other applications. For example, embodiments may be applicable to mobile phones, digital books, digital cameras, electronic game machines, digital music players, personal digital assistance (PDA), personal handy phone system (PHS), lap top computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

### First Embodiment

A mobile phone 10 according to the present embodiment is one type of mobile terminal, comprising a processor 24 that is a CPU or a computer. A wireless communication circuit 14, an A/D 16, a D/A 20, a key input device 26, a display driver 28, a flash memory 32, a RAM 34, a touch detection section 36, and an acceleration sensor 38 are connected to the processor 24. An antenna 12 is connected to the wireless communication circuit 14. A microphone 18 is connected to the A/D 16. A speaker 22 is connected to the D/A20, through an amplifier (not shown in the figures). A display 30 that functions as a display section is connected to the display driver 28. A panel 38 is connected to the touch detection section 36.

The RAM 34, referred to as a storage section, is used as a working area (including a drawing area) or a buffer area of the processor 24. Characters, images, voices, the data for contents such as sounds and videos are stored in the flash memory 32.

The A/D 16 converts analog audio signals for voices and sounds input through the microphone 18 that is connected to the A/D 16 into digital audio signals. The D/A 20 converts digital audio signals into analog audio signals (decode), and provides them to the speaker 22 through the amplifier. As a result, voices and sounds corresponding to analog audio signals are output from the speaker 22.

The key input device 26 has a talk key, an end key, etc. The information of the keys operated by the user (key data) is input into the processor 24. When the respective keys contained in the key input device 26 are operated, a clicking sound occurs. The user, when hearing the clicking sound, is able to obtain an operational feeling for the key operation. The display driver 28, under the command from the processor 24, controls the display of the display 30 that is connected to the display driver 28. The display driver 28 comprises a video memory that temporarily stores the image data that is displayed. The panel 38 is a plate-like transparent member that is disposed corresponding to the display 30. The panel 38 functions as one section of a pointing device for identifying the position of the finger of the user conducting the operation to the screen of the display 30. The touch detection section 36 identifies the position the finger when the finger touches the panel 38, and outputs the coordinate data showing the operated position to the processor 24. That is, the user, by pushing, stroking, or touching the upper surface of the panel 38, is able to input the direction of the operation, figures, etc., to the mobile phone 10. Identification of the position of the fingers is performed using a capacitance method. The capacitance method is a method for identifying the position of the finger by detecting changes in the capacitance between electrodes that are generated as the finger approaches the surface. For example, the touch detection section 36 detects that one or a plurality of fingers has touched the panel 38. For example, the touch detection section 38 detects the operation such as pushing, stroking, or touching the upper surface.

Here, the operation by which the user touches the upper surface of the panel 38 with his/her finger is called “touch.” In contrast, the operation by which the finger is released from the panel 38 is called “release.” The operation by which the user touches the upper surface of the panel 38 and continuously releases his/her finger is called “touch and release.” In the present embodiment, the operations performed to the panel 38, such as touch, release, and touch and release, are collectively referred to as “touch operations.”

Not only may the touch operation be performed with fingers, it may also be performed with other items such as a touch pen in which a conductor is attached to the tip. As a detection method of the panel 38, the capacitance method, which is a surface type, a resistive method, an ultrasonic method, an infrared method, and an electromagnetic induction method may also be used.

The acceleration sensor 40 is a 3-axis acceleration sensor, which is a semiconductor type, and the acceleration data of the respective axis are output to the processor 24. The processor 24 calculates the gradient of the mobile phone 10, that is, the angle, using an inverse trigonometric function, with respect to the values of the acceleration of the respective axes. The wireless communication circuit 14 is a circuit for performing wireless communications, using a CDMA method. For example, when the user sends an audio transmission command using the key input device 26, the wireless communication circuit 14, under the command from the processor 24, runs the audio transmission process, and through the antenna 12, outputs audio transmission signals. The audio transmission signals are transmitted to the telephone of the intended party through the base station and a communications network. When the receiving process is performed by the telephone of the intended party, the communicable state is assured, and the processor 24 performs call processing.

To explain normal communication processing in detail, the modulation audio signals that are sent from the telephone of the intended party are received by the antenna 12. Demodulation processing and decoding processing are performed on the received modulation audio signals by the wireless communication circuit 14. The received audio signals obtained from this processing are output from the speaker 22, after being converted into analog audio signals by the D/A 20. In contrast, the transmission audio signals that are imported through the microphone 18 are provided to the processor 24, after being converted into digital audio signals by the A/D 16. Under the command from the processor 24, encoding processing and modulation processing are performed on the transmission signals converted into digital audio signals by the wireless communication circuit 14, and are output through the antenna 12. As a result, the modulation audio signals are transmitted to the telephone of the intended party through the base station and the communications network.

When the calling signals from the telephone of the intended party are received by the antenna 12, the wireless communication circuit 14 notifies the processor 24 of the calls received (also referred to as incoming calls). Correspondingly, the processor 24 controls the display driver 28, and displays the origin information (telephone number) that is described in the incoming alert on the display 30. Simultaneously, the processor 24 outputs ringtones (also referred to as ringtones and incoming sounds) from the speaker.

When the user performs a response operation using the talk key, the wireless communication circuit 14, under a command from the processor 24, performs audio receiving processing, assuring a communicable state, and the processor 24 performs the above-mentioned normal call processing.

After a communicable state is reached, when the call end operation is performed using the end key, the processor 24 controls the wireless communication circuit 14 and transmits the call end signals to the intended party. After the call end signals are transmitted, the processor 24 ends the call processing. In case in which the call end signals are received from the intended party first, the processor 24 ends the call processing. Furthermore, regardless of the intended party, in case in which the call end signals are received from the mobile communications network, the processor 24 ends the call processing.

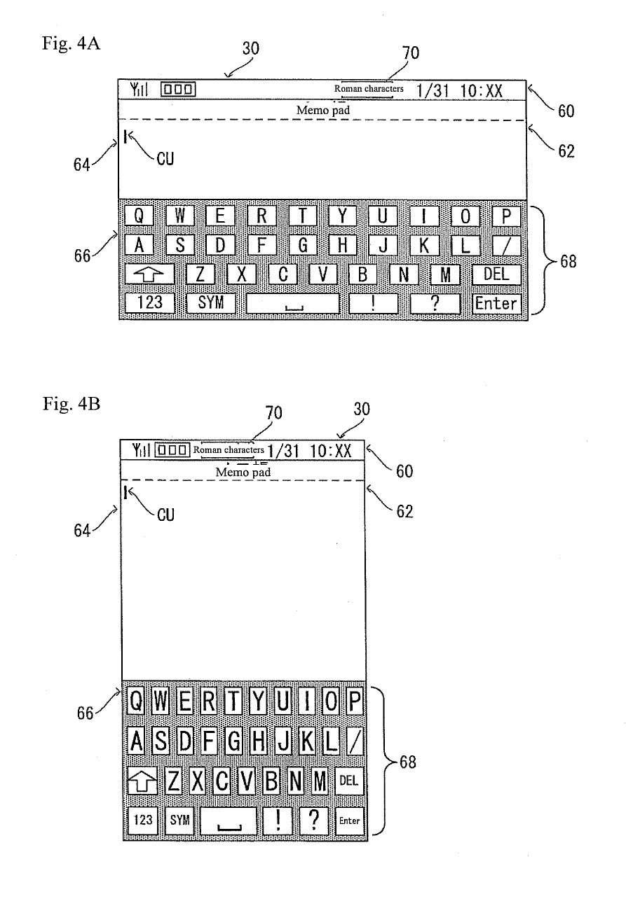

The mobile phone 10 comprises a memo pad function for composing sentences. When the memo pad function is executed, a character input key (refer to FIG. 4 A is displayed on the display 30.

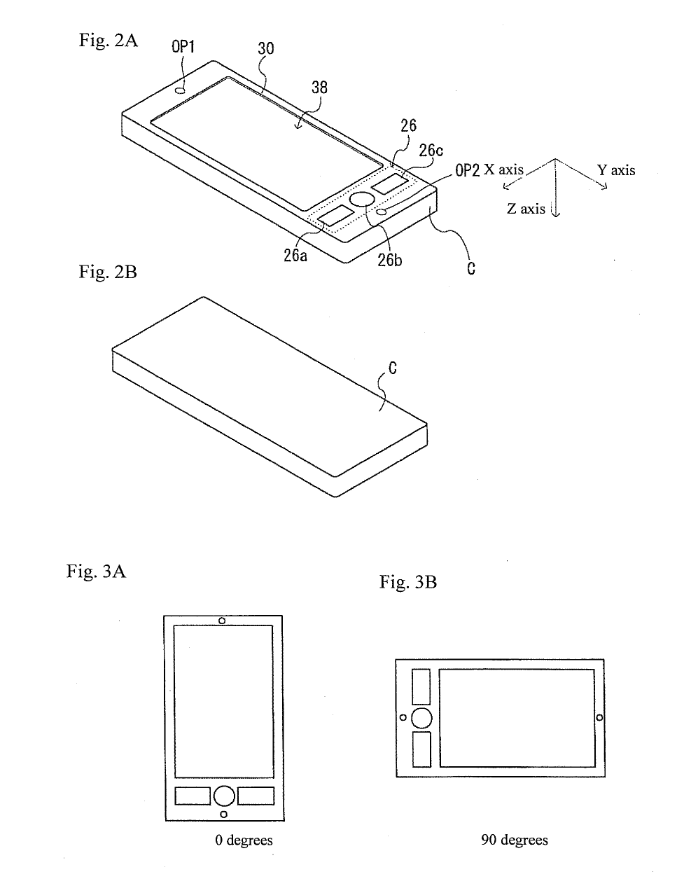

FIG. 2A is an exterior drawing showing the external appearance of the surface of the mobile phone 10. FIG. 2 (B) is an exterior drawing showing the external appearance of the rear surface of the mobile phone 10. The mobile phone 10 has a straight shape and is comprised of a flat rectangular housing C. The microphone 18, not shown in the figures, is built inside the housing C, and an opening OP2 that is connected to the built-in microphone 18 is provided on the surface on one lengthwise side of the housing C. Similarly, the speaker 22 is built inside the housing C, and an opening OP1 that is connected to the built-in speaker 22 is provided on the surface on the other lengthwise side of the housing C. The display 30 is attached such that the monitor screen can be observed from the surface side of the housing C. A panel 38 is disposed on the display 30.

The key input device 26 including various keys: has a talk key 26a, a function key 26b, and an end key 26c. These keys are disposed on the surface of the housing C.

For example, the user inputs telephone numbers by performing a touch operation and performs an audio transmission operation to the dial key displayed on the display 30 using the talk key 26a. When the call ends, the user performs a call end operation, using the end key 26c. The user selects or determines the menu by performing touch operations to the soft keys and the menu displayed on the display 30. The user turns the mobile phone 10 on and off by long pressing the end key 26c.

In FIG. 2A and FIG. 2 (B), the acceleration sensor 40 detects the respective acceleration in 3 axes: the longitudinal direction (Y axis direction), the lateral direction (X axis direction), and the depth direction (Z axis direction), of the mobile phone 10. The antenna 12, the wireless communication circuit 14, the A/D 16, the D/A 20, the processor 24, the display driver 28, the flash memory 32, the RAM 34, the touch detection section 36, and the acceleration sensor 40 are built inside the housing C; hence, they are not shown in FIG. 2A and FIG. 2 (B).

FIG. 3 A is a schematic diagram showing the state in which the mobile phone 10 is held in the longitudinal direction. FIG. 3 (B) is a schematic diagram showing the state in which the mobile phone is held in the lateral direction. The state shown in FIG. 3 A is referred to as the longitudinal direction state. When the user makes a call, the mobile phone 10 is held in the longitudinal direction state. In the longitudinal direction state, the processor 24 calculates 0 degrees, based on the acceleration data output by the acceleration sensor 40. In case in which the angle calculated by the processor 24 is 180 degrees, the mobile phone 10 is also placed in the longitudinal direction state.

As shown in FIG. 3 (B), when the lateral direction state is rotated 90 degrees rightwards from the longitudinal direction state, the mobile phone is placed in the lateral direction state. When the user inputs characters, there are cases in which the mobile phone 10 is held in the lateral direction state. In the lateral direction state, the processor 24 calculates 90 degrees based on the acceleration data output by the acceleration sensor 40. In case in which the processor 24 calculates 270 degrees, the mobile phone 10 is placed in the lateral direction state.

FIG. 4 A is a schematic diagram showing soft keys 68 in the lateral mode displayed in the lateral direction state. FIG. 4 (B) is a schematic diagram showing the soft keys 68 in the longitudinal mode displayed in the longitudinal direction state. As shown in FIG. 4 A, the display area of the display 30 in the state in which the memo pad function is executed, comprises a state display area 60 and a function display area 62. An icon showing the electric wave receiving state resulting from the antenna 12 (also known as a PICT), an icon showing the remaining battery capacity of rechargeable batteries, and the current date and time are displayed on the state display area 60. The current time is based on the time information output by the RTC.

The function display area 62 is divided into an input character display area 64 and a soft key display area 66. A cursor CU showing the current input position (edit position) is displayed on the input character display area 64. The soft keys 68, comprising character input keys in the QWERTY layout, are displayed on the soft key display area 66. These character input keys are displayed based on the touch area set for each character input key. When the touch operation is detected on the touch area corresponding to the character input keys, the processor 24 displays the characters corresponding to the key, based on the position of the cursor CU. Here, what is meant by the “touch area” of the character input keys, described in the present embodiment, refers to the area for inputting the characters corresponding to the character input keys, by touching with respect to that area. The “display area” for displaying the character input keys and the “touch area” are different areas.

The memo pad function can input characters of symbols, alphanumeric characters, and Japanese characters (Hiragana, Katakana, and Kanji). For inputting Japanese characters, a Kana input mode and a Roman character input mode of Japanese characters are provided. For example, in case in which the character input mode is set to input Roman characters, an input mode icon 70, written as “Roman characters,” is displayed on the state display area 60. When the user, based on the rule of Roman character input of Japanese characters, performs the touch operation to the touch area corresponding to the “A” key, according to the position of the cursor CU, the “ [symbol] (a)” character is displayed. When the “SYS” key is operated and when the input mode is changed, character strings shown on the input mode icon 70 also change.

As shown in FIG. 4 (B), the soft keys 68 in the longitudinal mode are displayed even in case in which the mobile phone 10 is placed in the longitudinal direction state. In this case, the number of lines that can be displayed on the input character display area 64 increases. Therefore, the user can change the position of the mobile phone 10 according to the state in which sentences are composed.

Furthermore, the memo pad function, based on the input characters, comprises a prediction function that predicts characters to be input next. For example, in case in which the characters to be input next are predicted, based on the rule of Roman character input, based on the characters of consonants that are input (such as K), characters of vowels (such as A), Hepburn style (S and H) characters, and characters of contracted sounds (Y) are predicted. The characters predicted to be input are also referred to as “prediction characters.”

Here, in the first embodiment, the display area of the character input keys corresponding to the predicted characters and the touch area corresponding to the character input keys are combined and enlarged. Following the flow of the character input, enlargement of the touch area is described below.

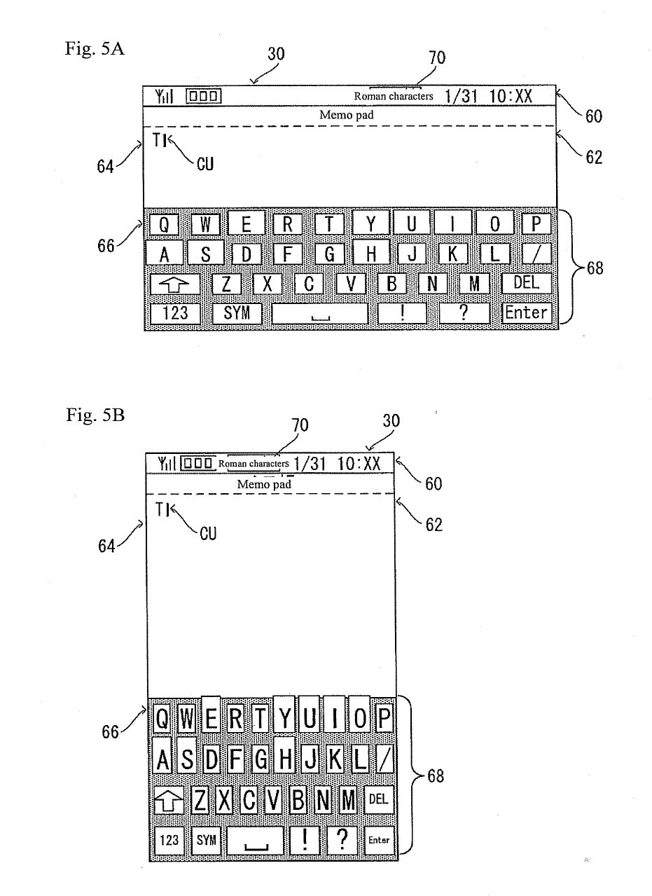

FIG. 5 A is a schematic diagram showing the state in which the display area of some character input keys and their corresponding touch area are enlarged in the soft keys 68 in the lateral mode. FIG. 5 (B) is a schematic diagram showing the state in which the display area of some character input keys and their corresponding touch area are enlarged in the soft keys 68 in the longitudinal mode. As shown in FIG. 5 A and FIG. 5 (B), for example, when the touch operation is performed to the “T” key, based on the rule of Roman character input, the touch areas with respect to the vowel keys “A,” “I,” “U,” “E,” and “O,” Hepburn style keys, “H” and “S,” and contracted sound keys, namely “Y,” are enlarged. That is, the display of the character input keys is also enlarged together according to the touch area, thereby legibility is improved.

In case in which the touch area is enlarged, it is enlarged so as not to overlap the touch area corresponding to other adjacent keys. For example, the touch area corresponding to the “Y” key is enlarged so as not to overlap not only the touch area corresponding to the “T” key which is not enlarged, but also so as not to overlap the touch area corresponding to the “U” key which is enlarged and which is located on the left side, and the “H” key which is enlarged and which is located on the lower side. That is, even if the touch area is enlarged, because the touch area corresponding to other character input keys is not affected, the operability for other character input keys can be maintained.

Furthermore, in case in which characters to be input next cannot be predicted based on the rule of Roman character input, the enlarged touch area is restored to the original size. For example, in case in which vowels such as “A” are input, with the rule of Roman character input only, it is difficult to predict the characters to be input next. Therefore, the enlarged touch area is restored to the original size. That is, in the state in which the characters likely to be input next cannot be predicted, when the touch area corresponding to some character input keys is enlarged, there is a possibility that the user may be confused. Therefore, in case in which it is not necessary to enlarge the touch area, the touch area corresponding to the character input keys is restored to the original size.

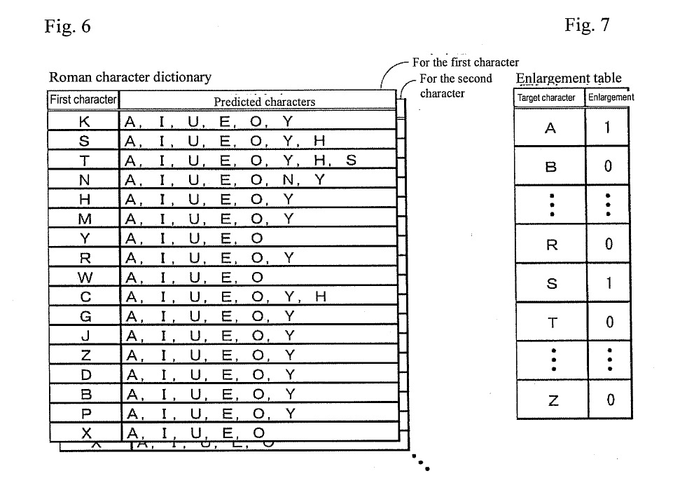

Next, the process for enlarging the touch area is described in detail. First, when Roman characters are input, the characters thereof are searched using the Roman character dictionary shown in FIG. 6, and predicted characters are read from the Roman character dictionary. As shown in FIG. 6, for example, if the character input as the first character is “T,” the predicted characters that are read are “A,” “I,” “U,” “E,” “O,” “H,” “S,” and “Y.” When the predicted characters are identified, the result of the predicted characters obtained is set in the enlargement table shown in FIG. 7. When the input character is for the second character, the predicted characters are read from the Roman character dictionary for the second character.

As shown in FIG. 7, the enlargement table includes the “target character” line and “enlargement” line. In the “target character” line for each row, 26 alphabet characters are set. In the “enlargement” line in the default state, “0” is recorded in all rows. When the predicted character is set, “1” is set for a field corresponding to the predicted character. For example, when the input character is “T,” “1” is recorded in the fields for the “enlargement” corresponding to the predicted characters, “A” and “S.” In the fields for the “enlargement” corresponding to “B,” “R,” “T,” and “Z,” which are not predicted characters, “0” is maintained.

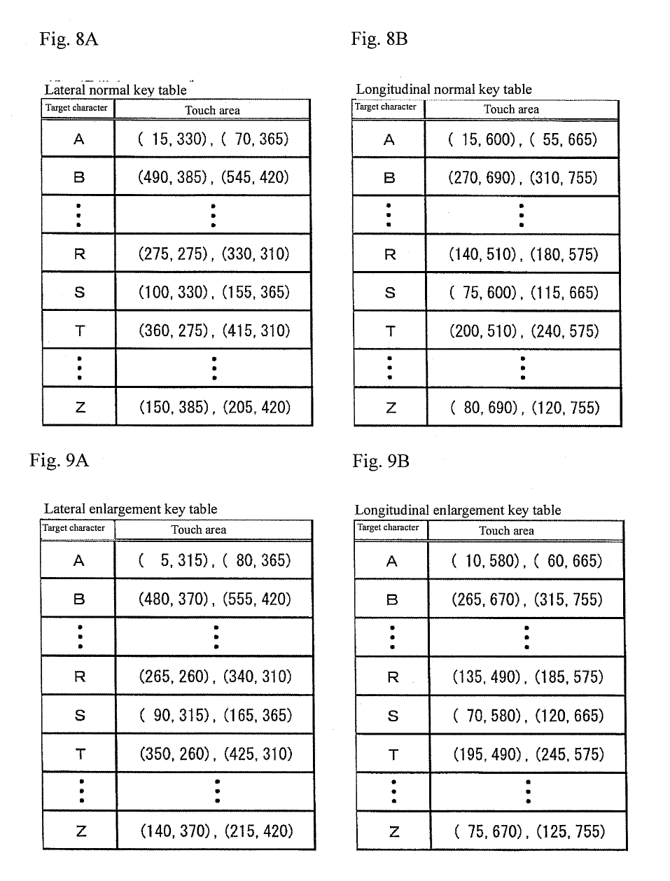

When the enlargement table is set, the touch area is set based on “0” and “1” that are set in the enlargement table. This touch area is shown as two coordinates (upper left and lower right). With reference to the lateral normal key table shown in FIG. 8 A, for example, the touch area corresponding to the “A” key is shown as the upper left coordinate (15 and 330) and the lower right coordinate (70 and 365).

When the mobile phone 10 is in the lateral direction state, the touch area of the characters in which “0” is set in the enlargement table is read from the lateral normal key table shown in FIG. 8 A. The touch area of the characters in which “1” is set in the enlargement table is read from the lateral enlargement key table shown in FIG. 9 A.

That is, the touch area of the key in which the touch area is not enlarged (hereinafter referred to as a normal key) is read from the lateral normal key table, and the touch area of the key in which the touch area is enlarged (hereinafter referred to as an enlargement key) is read from the lateral enlargement key table.

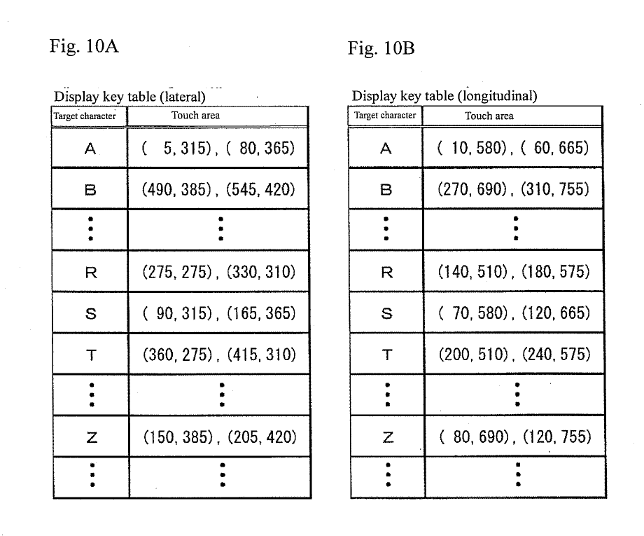

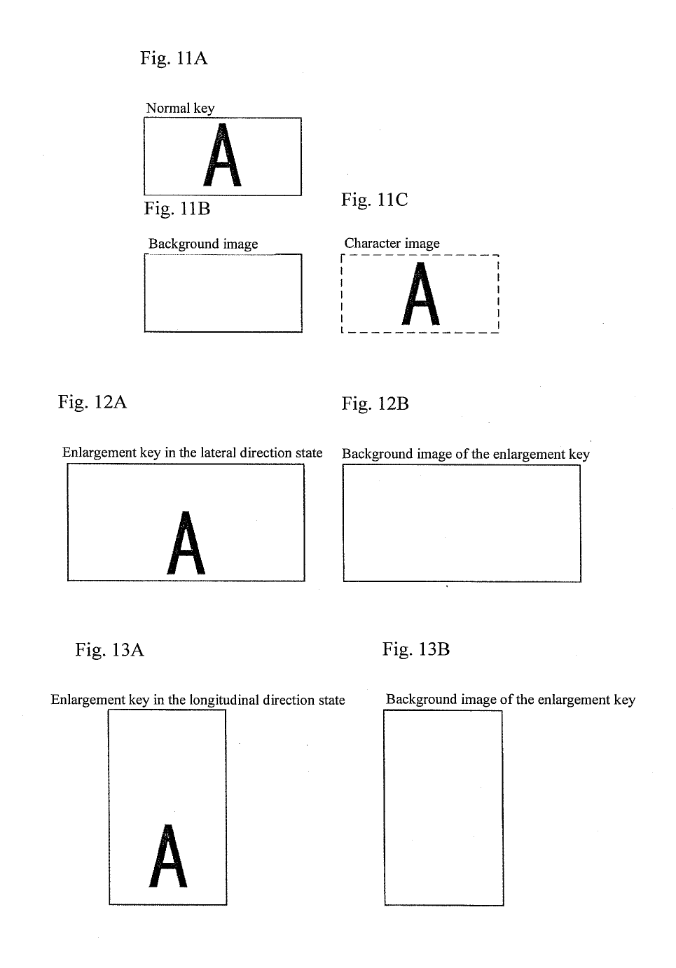

Next, when the mobile phone 10 is in the lateral direction state, the touch area that is read is set in the display key table shown in FIG. 10 A. As shown in FIG. 10 A, for example, the touch area corresponding to the “A” key, which is the enlargement key, (5, 315), (80, 365) and the touch area corresponding to the “S” key, which is the enlargement key, (90, 315), (165, 365) are read from the enlargement key table shown in FIG. 9 A. The touch area corresponding to the “B” key, which is the normal key, (490, 385), (545, 420), the touch area corresponding to the “R” key, which is the normal key, (275, 275), (330, 310), the touch area corresponding to the “T” key, which is the normal key, (360, 275), (415, 310), and the touch area corresponding to the “Z” key, which is the normal key, (150, 385), (205, 420) are read from the lateral normal key table shown in FIG. 8 A.

In the longitudinal direction state, based on the enlargement table in FIG. 7, the touch area is read from the longitudinal normal key table shown in FIG. 8 (B) and the longitudinal enlargement key table shown in FIG. 9 (B). The touch area corresponding to the normal key and the enlargement key that are read are set in the display key table shown in FIG. 10 (B).

In this way, using the key tables including the touch area that is previously set, the processing speed of the processor 24 that sets the touch area corresponding to the character input keys can be made faster.

Next, the key display that is drawn according to the touch area set is explained. As shown in FIG. 11A, for example, a key image for the “A” key, which is the normal key, is drawn on the display 30 to the background image shown in FIG. 11 (B), in the state in which the character image for “A” shown in FIG. 11 (C) is overlapping. That is, the key image for the “A” key comprises the background image and the character image. For other normal keys, as is the case with the “A” key, they comprise the background image shown in FIG. 11 (B) and the character image corresponding to the character input key.

As shown in FIG. 11C, the dotted line surrounding “A” shows the touch area corresponding to this key. The size of the touch area shown in the dotted line matches that of the background image shown in FIG. 11 (B).

Next, as shown in FIG. 12A, the “A” key, in which the touch area is enlarged in the lateral direction state, comprises the background image shown in FIG. 12 (B) and the character image shown in FIG. 11C. Furthermore, as shown in FIG. 13 A, the “A” key in which the touch area is enlarged in the longitudinal direction state, comprises the background image shown in FIG. 8 (B) and the character image shown in FIG. 11C.

In this way, for either the enlargement key or the normal key, with regard to the characters drawn inside the key, common image data is used. Furthermore, for the enlargement key drawn on the display 30, the background images shown in FIG. 12 (B) or FIG. 13 (B) are also used as common image data. In case in which the character input keys are drawn, because this common image data is used, the image data stored in the RAM 34 decreases. In this way, it is possible to save the memory capacity.

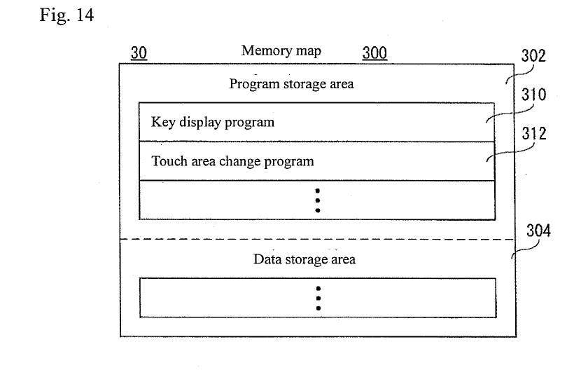

FIG. 14 is a schematic diagram showing a memory map 300 of the RAM 34. A program storage area 302 and a data storage area 304 are included in the memory map 300 of the RAM 34. Some of the programs and the data are partially and sequentially read all at once or as necessary from the flash memory 32, stored in the RAM 34, and processed by the processor 24.

A program for operating the mobile phone 10 is stored in the program storage area 302. For example, the program for operating the mobile phone 10 includes a key display program 310, a touch area change program 312, etc.

The key display program 310 is, for example, a program for displaying the soft keys 68 shown in FIG. 4 A and FIG. 4 (B), when the memo pad function is executed. The touch area change program 312 is a program for enlarging the touch area corresponding to the character input keys and for restoring it to the original size.

Programs for operating the mobile phone 10 include a program for notifying the state in which voices are received, a program for establishing the call state, a program for performing the memo pad function, etc.

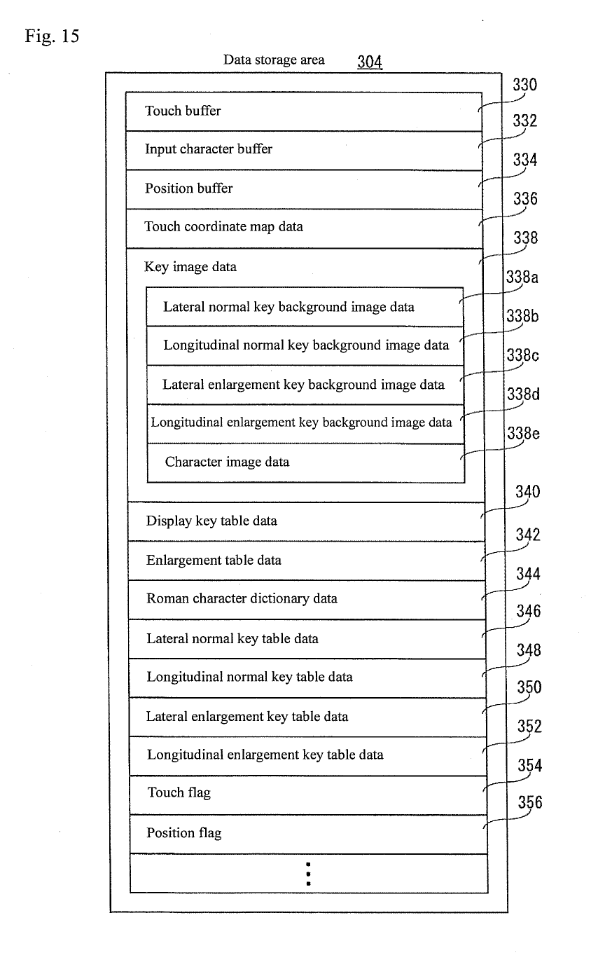

As shown in FIG. 15, the data storage area 304 comprises a touch buffer 330, an input character buffer 332, a position buffer 334, etc. A touch coordinate map data 336, key image data 338, display key table data 340, enlargement table data 342, Roman character dictionary data 344, lateral normal key table data 346, longitudinal normal key table data 348, lateral enlargement key table data 350, longitudinal enlargement key table data 352, etc., are also stored in the data storage area 304. Furthermore, the data storage area 304 comprises a touch flag 354 and a position flag 356, etc.

A coordinate that is output from the touch detection section 36 is temporarily stored in the touch buffer 330. The input characters resulting from the touch operation are temporarily stored in the input character buffer 332. For example, in the state shown in FIG. 5 A, “T” is stored in the input character buffer 332. The acceleration data of 3 axes that are output from the acceleration sensor 40 are temporarily stored in the position buffer 334.

The touch coordinate map data 336 is data for associating the touch coordinate of the touch operation with the display coordinate of the display 30. That is, the processor 24, based on the touch coordinate map data 336, associates the results of the touch operation performed to the panel 38 with the display of the display 30.

The key image data 338 is data for displaying key images shown in FIG. 11A, FIG. 12A, and FIG. 13 A. Therefore, the key image data 338 comprises lateral normal key background image data 338a shown in FIG. 11 (B), longitudinal normal key background image data 338b, which is not shown in the figures, lateral enlargement key background image data 338c shown in FIG. 12 (B), longitudinal enlargement key background image data 338d shown in FIG. 13 (B), and character image data 338e containing characters shown in FIG. 11C. The display key table data 340 is, for example, data shown in FIG. 10 A and FIG. 10 (B). The enlargement table data 342 is, for example, data shown in FIG. 7. The Roman character dictionary data 344 is, for example, data for the dictionary shown in FIG. 6.

The lateral normal key table data 346 is, for example, data shown in FIG. 8 A. The longitudinal normal key table data 348 is, for example, data shown in FIG. 8 (B). The lateral enlargement key table data 350 is, for example, data shown in FIG. 9 A. The lateral enlargement key table data 352 is, for example, data shown in FIG. 9 (B).

The touch flag 354 is a flag for determining whether or not the touch operation is being performed to the panel 38. For example, the touch flag 354 is a register having 1 bit. When the touch flag 354 is turned on (success), the data value “1” is se to the register t. On the other hand, when the touch flag 354 is turned off (failure), the data value “0” is set to the register.

The position flag 356 is a flag for determining the position of the mobile phone 10. When the position flag 356 is turned on, the mobile phone 10 is placed in the lateral direction state. On the other hand, when the position flag 356 is turned off, the mobile phone 10 is placed in the longitudinal direction state. The position flag 356 is switched on/off, based on the acceleration data stored in the position buffer 334.

Image data for displaying icons on the display 30, etc. are stored in the data storage area 304, and a counter and a flag, necessary to operate the mobile phone 10, are also stored in the data storage area 304.

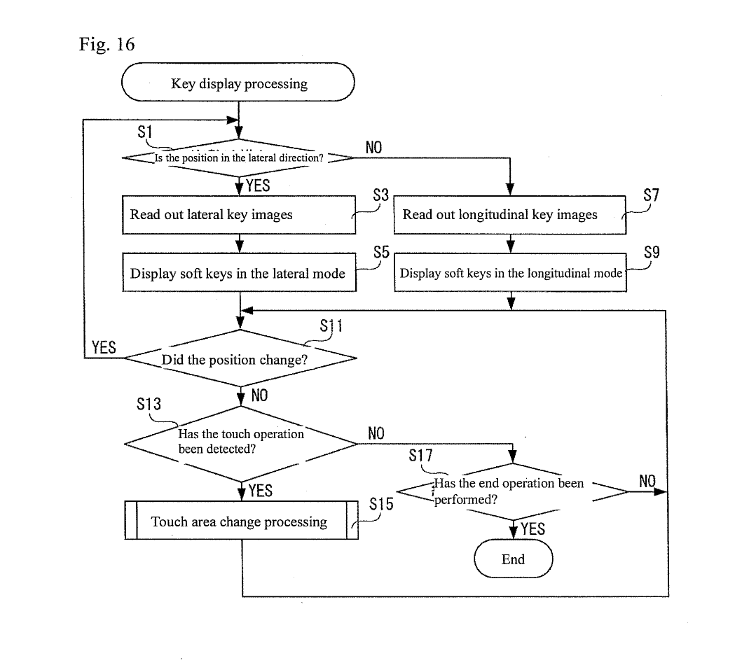

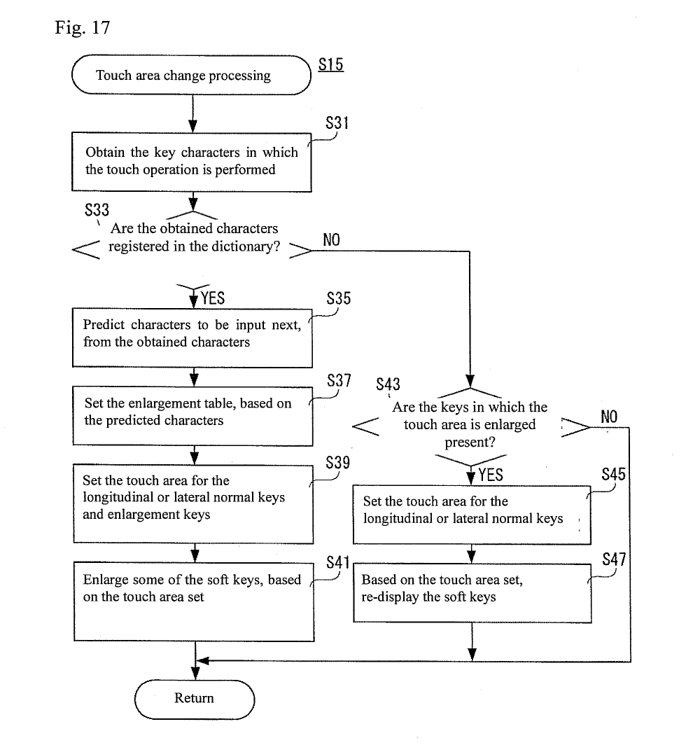

The processor 24 processes, in parallel, under the control of Android (registered trademark) and Linux (registered trademark)-based OS such as REX, and other OS's, a plurality of tasks, containing key display processing shown in FIG. 16 and coordinates range change processing shown in FIG. 17, etc.

FIG. 16 is a flow diagram of the key display processing. For example, in Step S1, when the operation for performing the memo pad function of the mobile phone 10 is performed, the processor 24 determines whether or not the position is in the lateral direction. That is, the processor 24, in order to determine whether or not the mobile phone 10 is in the lateral direction as shown in FIG. 3 (B), determines whether or not the position flag 356 is turned on.

If it is “YES” in Step S1, that is, if the mobile phone 10 is in the lateral direction state, the processor 24 reads the lateral key images in Step S3. That is, in Step S3, based on the enlargement table data 342, the lateral normal key background image data 338a, the lateral enlargement key background image data 338c, and the character image data 338e are read. Next, in Step S5, the processor 24 displays the soft keys 68 in the lateral mode. For example, as shown in FIG. 4 A, the soft keys 68 in the lateral mode are displayed on the display 30. If it is “NO” in Step S1, that is, if the mobile phone 10 is in the longitudinal direction state, the processor 24 reads the longitudinal key images in Step S7. That is, in Step S7, based on the enlargement table data 342, the longitudinal normal key background image data 338b, the longitudinal enlargement key background image data 338d, and the character image data 338e are read. Next, in Step S9, the processor 24 displays the soft keys 68 in the longitudinal mode. For example, as shown in FIG. 4 (B), the soft keys 68 in the longitudinal mode are displayed on the display 30.

Next, in Step S11, the processor 24 determines whether or not the position is changed. For example, in order to determine whether the mobile phone 10 changed from the lateral direction state to the longitudinal direction state, the processor 24 determines whether or not the position flag 356 is switched between on/off. If it is “YES” in Step S11, for example, if the mobile phone 10 changes from the longitudinal direction state to the lateral direction state, the processor 24 returns to the processing of Step S1.

If it is “NO” in Step S11, that is, if the position of the mobile phone 10 is not changed, in Step S13, the processor determines whether or not the touch operation is detected. That is, the processor 24, in order to determine whether the touch operation for inputting the characters is performed, determines whether or not the touch flag 352 is turned on. If it is “YES” in Step S13, that is, if the touch operation for the character input is detected, the processor 24 executes the touch area change processing in Step S15, and returns to the processing of Step S11. Because this touch area change processing is subsequently described, using the flow diagram shown in FIG. 17, a detailed explanation is omitted herein.

On the other hand, if it is “NO” in Step S13, that is, if the touch operation is not detected, the processor 24 determines whether or not the end operation is performed in Step S17. For example, the processor 24, as the end operation for ending the memo pad function, determines whether or not the end key 26c was operated. If it is “NO” in Step S17, that is, if the end operation is not performed, the processor 24 returns to Step S11. If it is “YES” in Step S17, that is, if the end operation is performed, the processor 24 ends the key display processing.

FIG. 17 is a flow diagram of the coordinate range change processing. When Step S15 is executed with the key display processing, the processor 24 obtains the characters of the keys to which the touch operation is performed in Step S31. For example, in case in which the touch operation is performed to the “T” key, because the “T” is stored in the input character buffer 332, the processor 24 obtains the “T” data from the input character buffer 332.

Next, the processor 24 determines whether or not the characters obtained are registered in the dictionary. For example, in Step S31, the processor 24 determines whether or not the characters obtained from the input character buffer 332 are registered. If it is “NO” in Step S33, that is, if the characters stored in the Roman character dictionary data 344 are not registered, the processor 24 proceeds to Step S43.

If it is “YES” in Step S35, that is, if the characters stored in the input character buffer 332 are registered in the Roman character dictionary data 344, in Step S35, the processor 24 predicts the characters to be input next from the obtained characters. For example, based on the Roman character dictionary data 344, the obtained character “T” is searched, and the predicted characters (“A”, “I”, “U”, “E”, “O”, “H”, and “S”) are read. The processor 24 for executing the processing of Step S35 functions as a prediction section.

Next, based on the characters predicted in Step S37, the enlargement table is set. That is, “1” is recorded in the fields corresponding to the predicted characters in the enlargement table shown in FIG. 7. That is, if “A” and “S” are contained in the predicted characters, as per the enlargement table shown in FIG. 7, “1” is recorded in the fields corresponding to “A” and “S” of the predicted characters.

Next, in Step S39, the touch area corresponding to the longitudinal or lateral normal key and enlargement key is set. That is, the processor 24 reads the touch area from the longitudinal or lateral enlargement key table and sets the characters in which “1” is recorded in the enlargement table in the display key table. The processor 24 reads the touch area from the longitudinal or lateral normal key table and sets the characters in which “0” is recorded in the display key table. That is, in case in which the touch area is set based on the enlargement table shown in FIG. 7, the display key table is set as shown in FIG. 10 A. The processor 24 for performing the processing of Step S39 functions as a touch area enlargement section.

Next, in Step S41, the processor 24 enlarges some of the soft keys 68, based on the touch area set. For example, in case in which the display key table is set as shown in FIG. 10 A, as shown in FIG. 5 A, the display of the keys “A,” “I,” “U,” “E,” “O,” “H,” and “S,” is also enlarged. When the processing of Step S41 ends, the touch area change processing is terminated and returns to the key display processing.

If the characters that are input are not registered in the Roman character dictionary, in Step S43, the processor 24 determines whether or not there are keys in which the touch area is enlarged. That is, the processor 24 determines whether or not there are fields in which “1” is recorded in the enlargement table data 342. If it is “NO” in Step S43, that is, if there are no enlargement keys, the processor 24 ends the touch area change processing. On the other hand, if it is “YES” in Step S43, that is, if there are keys in which the touch field is enlarged, in Step S45, the processor 24 sets the touch area corresponding to the longitudinal or lateral normal keys. That is, the processor 24 reads the touch area from the longitudinal or lateral normal key table and sets it in the display key table. “0” is recorded in all fields in the enlargement table. That is, in the processing of Step S45, the enlarged touch area is reset to the original touch area. The processor 24 for performing the processing of Step S45 functions as a reset section.

Next, in Step S47, based on the touch area that is set, the soft keys 68 are re-displayed. For example, in case in which the soft keys 68 are displayed as shown in FIG. 5 A, the soft keys 68 are displayed as shown in FIG. 4 A. The touch area change processing ends when the processing of Step S47 ends.

The processor 24 for performing the processing of Step S41 and Step S47 functions as the first display control section.

### Second Embodiment

In the second embodiment, unlike the first embodiment, even if the touch area is enlarged, the display area for the character input keys does not change. Because the mobile phone 10 in the second embodiment is the same as that in the first embodiment, overlapping explanations, such as the explanations of the electrical configuration and the external appearance of the mobile phone 10, are omitted.

For example, in the second embodiment, even if the characters to be input next are predicted, and even if the touch area is enlarged, the soft keys 68 are displayed as shown in FIG. 4 A, and FIG. 4 (B).

In this way, in the second embodiment, because the display of the character input keys does not change, the operability of the character input keys can be improved without providing a sense of discomfort with respect to the display to the user.

The processor 24 in the second embodiment performs the plurality of tasks in parallel, including the coordinate range change processing, instead of the flow shown in FIG. 17.

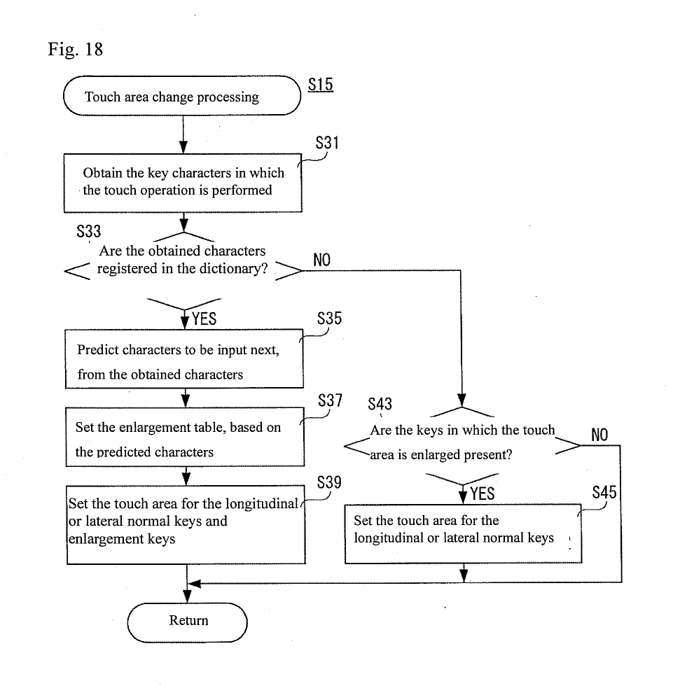

FIG. 18 is a flow diagram of the coordinate range change processing in the second embodiment. As shown in FIG. 18, in the coordinate range change processing in the second embodiment, Step S41 for enlarging the display area of the character input keys according to the touch area and Step S47 for restoring the enlarged display area to its original condition are omitted.

Therefore, when Step S15 in FIG. 16 is executed, the processor 24 performs the processing of Steps S31 to S39, and the touch area corresponding to the character input keys is enlarged. When the processing of Step S39 ends, the touch area enlargement processing is terminated and the processing returns to the key display processing.

On the other hand, if it is “NO” in Step S33, that is, if the characters stored in the input character buffer 332 are not registered in the Roman character dictionary data 344, and if the touch area is enlarged, the processor 24 performs Steps S43 and S45, and the enlarged touch area is restored to its original size. When the processing of Step S45 ends, as is the case in which the processing of Step S39 ends, the processing returns to the key display processing.

In the second embodiment, the processor 24 functions as the second display control section.

As can be understood from the above explanation, the mobile phone 10 comprises the display 30 that is disposed at the position corresponding to the panel 38; and the touch detection section 36 that detects the touch operation to the panel 38. On the display 30, the soft keys 68 in the QWERTY layout are displayed, and the characters are input when the touch operation is performed to the soft keys 68. The mobile phone 10 also comprises the prediction function that predicts the characters to be input next, based on the characters input. When the characters are input resulting from the touch operation, the processor 24 predicts the characters to be input next and enlarges the touch area corresponding to the character keys, so as not to overlap with the touch area corresponding to other keys.

Therefore, the touch area corresponding to the keys is enlarged and the operability of the keys improves.

In the present embodiment, based on the rule of Roman character input, which is commonly used for inputting Japanese characters, the characters to be input next can be predicted.

In another embodiment, as the dictionary for predicting the characters that are input, a learning type prediction suggestion dictionary that is used for “iWnn (registered trademark),” etc., a prediction suggestion dictionary for English that is used for prediction conversion of English, such as “POBox (registered trademark) Pro E,” and an English word dictionary that includes English words, etc., may be used. In case in which the touch area is enlarged using these dictionaries, the touch area is enlarged corresponding to the first character of the word in the top rank of the prediction suggestion. For example, when “S” is input, if the first rank of the prediction suggestion is “summer,” the touch area corresponding to “U” is enlarged. Furthermore, if the subsequent suggestion in this case is “simple,” the touch area corresponding to the “I” key is also enlarged. That is, in another embodiment, because the characters to be input next are predicted, based on words or sentences that the user inputs, the touch area corresponding to the character input key is accurately enlarged.

The key layout of the soft keys 68 is not solely limited to the QWERTY layout; it may be the ABC layout, the QWERTZ layout corresponding to German, the AZERTY (ASERTY) layout corresponding to French, the layout of the phonetic alphabet sequence corresponding to Chinese, the Hangul layout corresponding to Korean, the Hiragana 50-character layout, the Hiragana/Katakana JIS layout, the key layout corresponding to input of numbers/symbols, etc.

Not only may the prediction function be executed with the memo pad function, it may also be executed in the function that transmits messages such as e-mails and SMS (Short Message Service), the address book function, the browser function, and the title edit function for images.

As the communication method of the mobile phone 10, the CDMA method is used; however, the LTE (Long Term Evolution) method, W-CDMA method, GSM method, TDMA method, FDMA method, PHS method, etc., may also be used.

The key display program 310 and the touch area change program 312 may be stored in the HDD of the server for data distribution and delivered to the mobile phone 10 through communications. The storage media may be sold or distributed in the state in which these programs are stored in optical disks such as CD, DVD, BD (Blue-ray Disc) and storage media such as USB memory and memory cards.

Furthermore, not only may the present embodiment be applied to the mobile phone 10, it may also be applied to smartphones, PDA (Personal Digital Assistant), etc.

Specific numerical values such as the coordinates showing the touch area, as described in the present specifications, are all just examples, and can be changed appropriately depending on the need, such as the specifications of the product.

Based on the above embodiment, the details of the disclosed invention are as follows.

The first invention is a mobile terminal comprising: a panel; a display section that displays the plurality of character input keys; and a touch detection section that detects a touch operation. When the touch operation is detected on the touch area of the touch detection section corresponding to the plurality of character input keys. The mobile terminal further comprises: the prediction section that predicts the characters most likely to be input next, when the characters are input, resulting from the touch operation; and the touch area enlargement section that enlarges the touch area corresponding to the character input keys of the characters that are predicted by the prediction section.

In the first invention, the mobile terminal (10: referring to the symbols describing the corresponding sections in the embodiment. Hereinafter, the same applies) comprises: the panel (38), the display section (30) that displays the plurality of character input keys; and the touch detection section (36) that detects the touch operation for the character input. For the mobile terminal, when the touch operation is detected on the touch area corresponding to the character input keys, the characters are input. Therefore, what is described here as the “touch area” of the character input keys refers to the area for inputting the characters corresponding to the character input keys, by touching to that area. When the characters are input resulting from the touch operation, the prediction section (24, S35) predicts the characters most likely to be input next, based on the rule of the character input, input history, etc. The touch area enlargement section (24, S39) enlarges the touch area corresponding to the character input keys of the predicted characters.

According to the first invention, the touch area corresponding to the character input keys is enlarged, the operability of the character input keys improves, and the legibility of the character input keys is also maintained.

The second invention is dependent of the first invention, and comprises the first display control section that displays the plurality of character input keys on the display section, according to the size of the touch area.

In the second invention, the first display control section (24, S41, S47) displays the plurality of character input keys on the display section, according to the size of the touch area. The “display area” for displaying the character input keys differs from the “touch area” described above; however, it is enlarged as the touch area is enlarged.

According to the second invention, because the display of the character input keys is also enlarged accordingly, the legibility of the character input keys improves.

The third invention is dependent of the first invention, and comprises the second display control section that, even in case in which the touch area of the touch detection section is enlarged, displays on the display section without changing the size on the display section of the plurality of character input keys.

In the third invention, the second display control section (24), even in case in which the touch area of the touch detection section is enlarged, displays on the display section without changing the size on the display section of the plurality of character input keys. In the third invention, unlike the second invention, even if the touch area is enlarged, the display area of the character input keys does not change.

According to the third invention, because the display of the character input keys does not change, the operability of the character input keys can be improved without providing a sense of discomfort with respect to the display to the user.

The fourth invention is dependent of either one of the first invention or the third invention, and the touch area enlargement section enlarges the touch area corresponding to the character input keys of the characters predicted by the prediction section, so as not to overlap with the touch area corresponding to other character input keys.

According to the fourth invention, even if the touch area is enlarged, because other touch areas are not affected, the operability of the character input keys in which the touch area is not enlarged can be maintained.

The fifth invention is dependent of either one of the first invention or the fourth invention, and comprises the reset section that resets the enlarged touch area to the original touch area when the characters most likely to be input next cannot be predicted by the prediction section and when the touch area is enlarged by the touch area enlargement section.

In the fifth invention, for example, the mobile terminal comprises the dictionary for predicting the characters most likely to be input next. The prediction section cannot predict the characters most likely to be input next when the characters that are input are not registered in the dictionary. Therefore, the reset section (24, S45) resets the enlarged touch area to the original touch area when the characters that are input are not registered in the dictionary for prediction purposes and when the touch area corresponding to the character input keys is enlarged.

In case in which the characters most likely to be input next cannot be predicted, there is a possibility that the user may be confused when the touch area corresponding to some character input keys is enlarged. Therefore, according to the fifth invention, if it is not necessary to enlarge the touch area, the size of the touch area corresponding to the character input keys is restored to its original size.

The sixth invention is dependent of either one of the first invention or the fifth invention, and further comprises the storage section that stores the key table showing the touch area corresponding to the character input keys, wherein the key table comprises the enlargement key table showing the enlarged touch area and the normal key table showing the normal touch area, and the display section displays the character input keys, based on the enlargement key table and the normal key table.

In the sixth invention, the key table showing the touch area corresponding to the character input keys is stored in the storage section (34). This key table includes the enlargement key table showing the enlarged touch area and the normal key table showing the normal touch area. The display section displays the character input keys, based on the touch area that is read from the enlargement key table and the normal key table.

According to the sixth invention, by using the key table that includes the touch area that is set previously, the processing speed for setting the touch area corresponding to the character input keys can be set quickly.

The seventh invention is dependent of either one of the first invention or the sixth invention, and the prediction section predicts the characters most likely to be input next, based on the rule of Roman character input of Japanese characters.

According to the seventh invention, the characters to be input next can be predicted, based on the rule of Roman character input, which is generally used for inputting Japanese characters.

The eighth invention is dependent of either one of the first invention or the sixth invention, and the prediction section predicts the characters most likely to be input next, based on frequency of the use of words.

According to the eighth invention, the characters to be input next are predicted, based on the words or sentences that the user inputs; therefore, the touch area corresponding to the character input keys is accurately enlarged.

The ninth invention comprises the panel (38); the display section (30) that displays the plurality of character input keys (68); and the touch detection section (36) that detects the touch operation, and the invention is the key display program that causes the processor (24) of the mobile terminal (10), to which the characters are input when the touch operation is detected on the touch area of the touch detection section corresponding to the plurality of character input keys, to function as the prediction section (S35) that predicts the characters most likely to be input next when the characters are input resulting from the touch operation, and as the touch area enlargement section (S39) that enlarges the touch area corresponding to the character input keys of the characters predicted by the prediction section.

Even for the ninth invention, as is the case with the first invention, the touch area corresponding to the character input keys is enlarged and the operability of the character input keys improves.

The tenth invention is the key display method of the mobile terminal (10) comprising: the panel (38); the display section (30) that displays the plurality of character input keys; and the touch detection section (36) that detects the touch operation, and in which, when the touch operation is detected on the touch area of the touch detection section corresponding to the plurality of character input keys, the characters are input, wherein when the characters are input resulting from the touch operation, the characters most likely to be input next are predicted and the touch area corresponding to the character input keys of the characters predicted is enlarged.

Even for the tenth invention, as is the case with the first invention, the touch area corresponding to the character input keys is enlarged and the operability of the character input keys improves.

According to the present invention, because the touch area corresponding to the keys is not enlarged, the operability of the keys improves.

While at least one exemplary embodiment is presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being comprised within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile terminal comprising:
a display section that displays a plurality of character input keys;
a panel that is disposed, corresponding to the display section;
a touch detection section that detects a touch operation to the panel; and
a processor inputs, when the touch operation to the panel is detected by the touch detection section, based on the touch operation, the character input keys included in the plurality of character input keys that are displayed on the display section, and enlarges the touch area of the character input keys that are predicted to be input next, so as not to overlap with the touch area of other character input keys.

2. The mobile terminal according to claim 1, wherein
the processor resets the touch area that is enlarged to the original touch area when the touch area is enlarged by the touch area enlargement section and characters likely to be input next cannot be predicted.

3. The mobile terminal according to claim 1 further comprising:
a storage section that stores a key table showing the touch area of the character input keys; wherein
the key table comprises an enlargement key table showing the enlarged touch area and a normal key table showing the normal touch area, and
the display section displays the character input keys, based on the enlargement key table and the normal key table.

4. The mobile terminal according to claim 1, wherein:
the prediction section predicts characters most likely to be input next, based on the rule of Roman character input for Japanese characters.

5. A key display program that causes
a processor of a mobile terminal, comprising: a display section that comprises a panel and displays a plurality of character input keys; and a touch detection section that detects a touch operation, and in which characters are input when the touch operation is detected on the touch area of the plurality of character input keys,
to function as a prediction section that predicts characters most likely to be input next, when characters are input resulting from the touch operation, and as a touch area enlargement section that enlarges the touch area of the character input keys corresponding to the characters that are predicted by the prediction section so as not to overlap with the touch area of other character input keys.

6. A key display method of a mobile terminal comprising: a display section that comprises a panel and displays a plurality of character input keys; and a touch detection section that detects a touch operation, and in which characters are input when the touch operation is detected on the touch area of the plurality of character input keys, wherein
when the characters are input, resulting from the touch operation, the characters most likely to be input next are predicted, and
the touch area of the character input keys corresponding to the predicted characters is enlarged, so as not to overlap with the touch area of other character input keys.
